(19) United States
(12) Patent Application Publication
(10) Pub. No.: US 2005/0241774 A1
(43) Pub. Date: Nov. 3, 2005

(54) Apparatus and process for aligning materials during a splice

(75) Inventors: Daniel John Hart, Appleton, WI (US); David L. Fugate, Appleton, WI (US)

Correspondence Address: DORITY & MANNING, P.A., POST OFFICE BOX 1449, GREENVILLE, SC, 29602-1449, US

(73) Assignee: Kimberly-Clark Worldwide, Inc.

(21) Appl. No.: 10/836,091

(22) Filed: Apr. 30, 2004

(51) Int. Cl. B65H 21/00; B31F 5/00

(52) U.S. Cl. 156/502; 156/504; 156/157; 242/551

(57) ABSTRACT

A splicing device is disclosed for splicing a first material to a second material in order to continuously feed the materials into a processing line. The apparatus includes a first roll letoff for unwinding a material into a processing line and a second roll letoff for holding a new material that is to replace the first material. The apparatus includes at least one sensor that indicates the position of one of the materials in the cross machine direction. A controller is used to compare the position of one material to the position of another material. If the materials are out of alignment in the cross machine direction, a shifting device shifts one of the materials until the materials are in alignment. The shifting device, for instance, may shift the splicing assembly itself while one of the materials is anchored to the splicing assembly.

### BACKGROUND OF THE INVENTION

The manufacture of products such as disposable absorbent articles involves the use of flexible materials. The flexible materials can include, by way of illustration, nonwoven materials, elastic materials, adhesive tapes, polymeric films, release paper, mechanical fastening materials, paper webs, and the like. During the formation of products, these materials are typically unwound from relatively large rolls of material and fed into a process where the material is manipulated, possibly combined with other materials, and formed into products.

When feeding a roll of material into a process, typical unwind systems may include an unwind device that is configured to hold a roll of material and to unwind the material. Such systems can also include a splicing device, a festoon, and a dancer roll. Festoons are designed to accumulate and temporarily hold a limited length of material. The accumulated material may then be released when unwinding of the material is temporarily interrupted. Such temporary interruptions can, for example, occur when splicing a first material to a second material.

The basic purpose of a dancer roll is to feed the material into a downstream process under substantially constant tension. Dancer rolls are described in detail in U.S. Pat. No. 6,473,669 to Rajala, et al. which is incorporated herein by reference.

Splicing devices are for splicing a first material to a second material when the roll containing the first material is exhausted and needs to be replaced by a second full roll of material. During a splicing sequence, the second material is attached to the first material, the first material is severed if necessary, and the second material is then fed into the process. In order to maintain a continuous process, all of the above steps must occur very rapidly and the second material must be closely aligned with the first material at the point of attachment. Specifically, misaligned splices may not only cause processing problems but may also produce non-uniform products.

In the past, the first material and the second material were each placed on the machine center line prior to being spliced together and expected to maintain alignment. Misalignment, however, remains a problem due to operator interaction, material variability, and the like. As such, a need currently exists for an improved apparatus and method for aligning materials prior to and during a splicing sequence.

### SUMMARY OF THE INVENTION

In general, the present invention is directed to an apparatus for splicing a first material to a second material. The apparatus may include, for instance, a first unwind station for unwinding a first roll of material into a processing line in the machine direction. A second unwind station may be present for unwinding a second roll of material into the processing line. In accordance with the present invention, a splicing device may be positioned to receive the first material from the first unwind station and the second material from the second unwind station. The splicing device may include a material holding device for holding a free end of the first material at a determined location or predetermined position. The position of the free end may be determined, for instance, by including guides that receive the free end in the splicing device and/or by a sensor that indicates the position of the free end.

The splicing device further includes a material joining device that is selectively engageable with the first and second materials. The material joining device is configured to attach the first and second materials together.

The apparatus further includes a shifting device connected to the splicing device. The shifting device is configured to move the splicing device in a cross machine direction. When moving the splicing device in the cross machine direction, the lateral position of the first material is changed when the first material is being held by the material holding device.

The apparatus can include at least one sensor for sensing the position of the materials. For instance, a first sensor may be used for determining the position of the first material while a second sensor may be used for determining the position of the second material in the cross machine direction. The first sensor and the second sensor may determine the position of the respective materials in various ways. For instance, in one embodiment, the sensors sense the position of a vertical edge of the material for determining the position of the material. In this embodiment, the apparatus assumes that the material has a uniform width for calculating the center of the material.

In an alternative embodiment, the first sensor and/or the second sensor may sense both vertical edges of the material. This information can then be used to calculate the center of the material as desired. As used herein, the term “sensor” encompasses a device containing multiple sensors such as when sensing both vertical edges of a material.

A controller may be placed in electrical communication with the first sensor and/or the second sensor and the shifting device. The controller can be configured to compare the position of the first material at the determined location with the position of the second material based upon information received from the sensors. Based upon the comparison, the controller may be further configured to control the shifting device for aligning the first material with the second material during a splicing operation.

If desired, the splicing device may further include a cutting device for cutting the second material after the second material is spliced to the first material. In this manner, the second material is fed into the processing line until exhausted. Once exhausted, the second material is aligned with the first material and the materials are spliced together. After the materials are spliced together, the second material is then cut and the first material is released into the processing line for further processing.

The material holding device contained within the splicing device can be any device suitable for holding a free end of the first material. The holding device, for instance, may be a clamp or may be a suction device that holds the material against a surface. The sensors contained within the apparatus may be, in one embodiment, optical sensors. The sensors may be placed at any suitable location. For most applications, however, the sensors should be positioned so as to sense the position of the first material and/or the second material in close proximity to the material joining device.

The material joining device may be any suitable device capable of joining two materials together. In one embodiment, for instance, the material joining device may simply be a vice or clamp that brings the two materials together. In this embodiment, tape or glue may be applied to one of the materials so that the materials become attached when joined. Alternatively, the material joining device may be a thermal bonding device or an ultrasonic bonding device.

The shifting device may vary depending upon the particular application. The shifting device may be, for instance, a fluid cylinder, such as a hydraulic cylinder or a pneumatic cylinder. In an alternative embodiment, the shifting device may be a ball screw that moves the splicing device in the cross machine direction.

In one particular embodiment, the apparatus may further include a material accumulator positioned downstream from the splicing device. The accumulator may be configured to accumulate a determined length of material sufficient to sustain temporary stoppages by the splicing device during operation of the processing line. The accumulator may be, for instance, a festoon. The festoon may include a first set of guide rolls spaced from a second set of guide rolls. The first set of guide rolls may be in operative association with a carriage. The carriage may be movable towards the second set of guide rolls for releasing material from the festoon during temporary stoppages.

The controller used in the apparatus of the present invention may be any suitable electronic device capable of controlling the various functions and receiving information from the various sensors. The controller may be, for instance, a microprocessor, such as a programmable logic unit. The controller may also be a plurality of microprocessors if desired.

In the embodiment described above, the free end of the first material is held in the splicing device while the splicing device is moved in relation to the second material for aligning the first material with the second material.

It should also be understood, that the apparatus of the present invention may be dual sided such that the apparatus is capable of not only splicing the first material to the second material but is also capable of splicing the second material to the first material.

Other features and aspects of the present invention are discussed in greater detail below.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1A is a perspective view of one embodiment of a splicing device made in accordance with the present invention;

FIG. 1B is a further perspective view of the splicing device illustrated in FIG. 1A;

FIG. 2 is a perspective view of a splicing device made in accordance with the present invention illustrating a controller that may be used to automatically align materials being fed through the splicing device; and

FIG. 3 is a perspective view of a processing line containing a splicing device made in accordance with the present invention.

Repeat use of reference characters in the present specification and drawings is intended to represent the same or analogous features or elements of the invention.

### DETAILED DESCRIPTION OF THE INVENTION

It is to be understood by one of ordinary skill in the art that the present discussion is a description of exemplary embodiments only, and is not intended as limiting the broader aspects of the present invention, which broader aspects are embodied in the exemplary construction.

In general, the present invention is directed to an improved apparatus that is designed to splice together a first material and a second material and to an improved process for splicing the two materials together. More particularly, the apparatus of the present invention includes various controls that automatically align a first material with a second material in the cross machine direction just prior to a splicing operation so that the two materials are in alignment when spliced together. By maintaining the two materials in alignment during a splicing sequence, the spliced materials are generally attached together more firmly. Material irregularities are also prevented allowing for the production of more uniform products. Further, maintaining the two materials in alignment during a splice also facilitates processing of the material and prevents against various processing problems that can occur should the two materials be out of alignment.

In general, any suitable materials may be unwound and spliced together in accordance with the present invention. For example, representative of materials that may be processed according to the present invention include nonwoven materials, elastic materials, composite materials, adhesive tapes, polymeric films, mechanical fastening materials, paper webs, tissue products, and the like. These materials may be fed into a process during the formation of various different types of products. For example, the materials may be fed into a process and manipulated in order to form personal care articles, diapers, incontinence pads, feminine hygiene products, child training pants, adult incontinence products, tissue products, and the like.

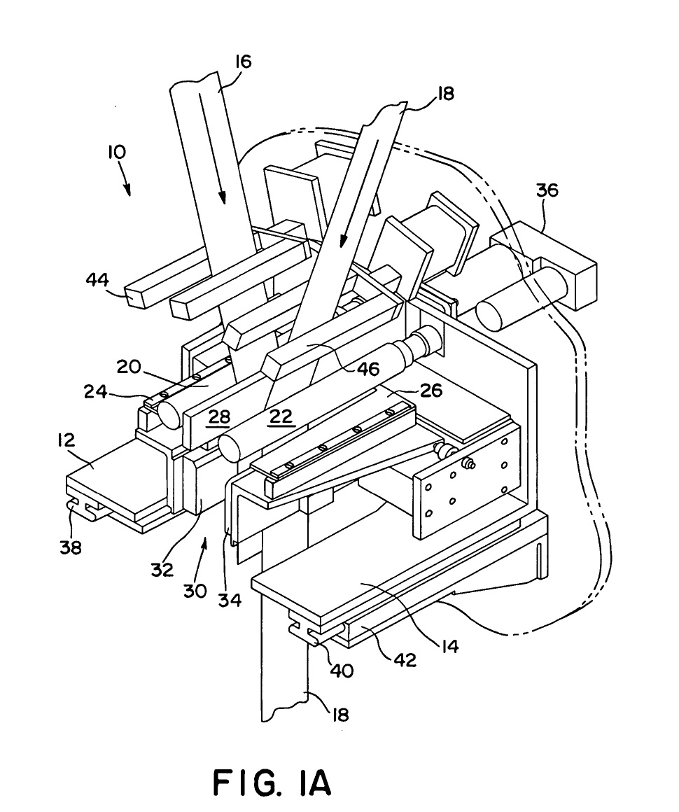

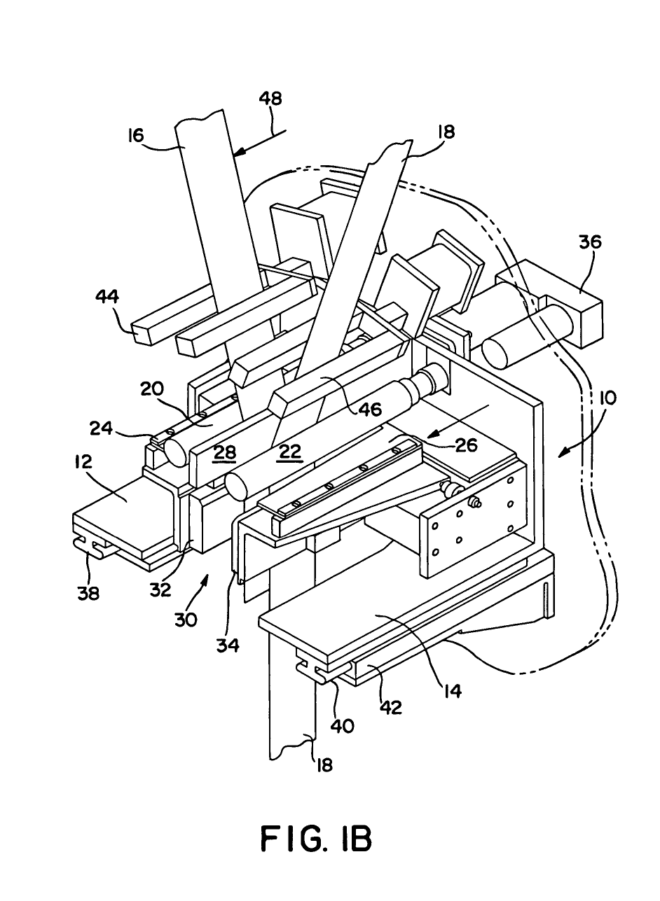

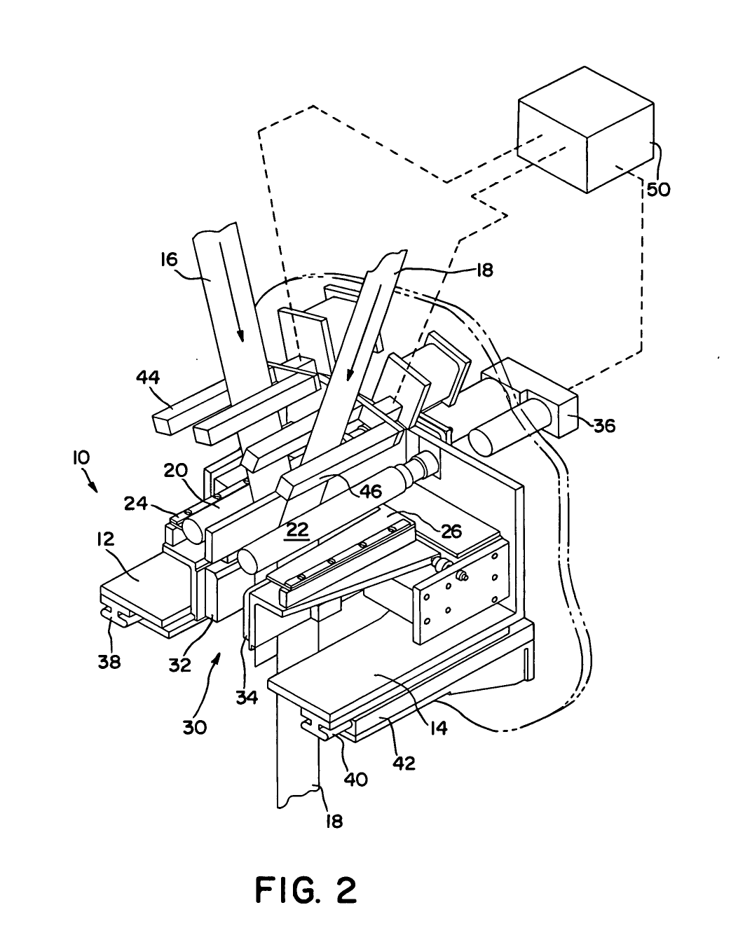

Referring to FIGS. 1A, 1B and 2, one embodiment of an apparatus made in accordance with the present invention is shown. Referring to FIG. 1A, a splicing device generally 10 is illustrated. The splicing device 10 includes a first side 12 and a second side 14. As shown, a first material 16 and a second material 18 are being fed into the splicing device 10. In this embodiment, the second material 18 represents the expiring web that is being fed into a downstream process. The first material 16, on the other hand, represents a new web that is to be spliced to the second material 18 when the second material is completely exhausted. Not shown, the first material 16 and the second material 18 may be contained on a roll that is unwound when the material is being fed into the process. For instance, the first material 16 may be supplied from a first roll of material that is positioned at a first unwind station. Likewise, the second material 18 may be supplied from a second roll of material that is being unwound from a second unwind station.

The splicing device 10 includes a first guide roll 20 in communication with the first material 16 and a second guide roll 22 in communication with the second material 18. In order to cut the first material and the second material at selected times, the splicing device 10 further includes a first knife 24 and a second knife 26. The first knife 24 and the second knife 26 are movable. For instance, when one of the materials needs to be severed such as during a splice operation, the knives 24 and 26 can traverse across the splicing device 10 and contact an anvil 28 causing the materials to sever.

Located below the anvil 28 is a material joining device generally 30. The material joining device 30 is for attaching the first material 16 to the second material 18 at selected times when a splice is desired. The material joining device 30 may be any suitable device capable of joining a first material or web to a second material or web. For instance, the material joining device 30 may be an ultrasonic bonding device or a thermal bonding device. In the embodiment shown in FIG. 1A, the material joining device 30 includes a first contact surface 32 spaced from a second contact surface 34. In this embodiment, the first material 16 is threaded into the splicing device 10 containing an adhesive or a piece of tape along an outer free edge. When it is time to splice the first material 16 to the second material 18, the contact surfaces 32 and 34 are brought together causing the first material 16 to attach to the second material 16 due to the presence of the adhesive or the tape.

In accordance with the present invention, the splicing device 10 further includes a shifting device 36. The shifting device 36 is configured to move the splicing device 10 in the cross machine direction. In order to stabilize the splicing device 10 during movement, the splicing device may further include a first sliding member 38 positioned on the first side 12 and a second sliding member 40 positioned on the second side 14. The sliding members 38 and 40 are received within corresponding tracks. For instance, sliding member 40 is shown within a track 42. When the shifting device 36 moves the splicing device 10 in the cross machine direction, the sliding members 38 and 40 move within the tracks, such as track 42.

The shifting device 36 can be any suitable device capable of moving the splicing device 10 in the cross machine direction. For instance, in one embodiment, a fluid cylinder, such as a hydraulic cylinder or a pneumatic cylinder may be used. In another embodiment, the shifting device 36 may be a ball screw. For instance, suitable ball screws for use in the present invention are commercially available from the Fife Corporation of Oklahoma City, Okla.

The splicing device 10 further includes at least one sensor for sensing the position of one of the webs. The sensors may be positioned at any suitable location that is proximate to the material joining device 30. As shown in FIG. 1A, for instance, the splicing device 10 includes at least a first sensor 44 and a second sensor 46. First sensor 44 is provided for determining the cross machine position of the first material 16, while the second sensor 46 is for determining the cross machine position of the second material 18. In general, any suitable sensing device may be used that is capable of sensing the position of the materials. In one embodiment, for instance, a photosensor may be used. An example of a photosensor, for instance, is the SE-23 infrared sensor commercially available from the Fife Corporation. The infrared sensor, for instance, may emit a modulated infrared light opposite a light detector. When positioned within the sensor, the materials block light transmission indicating the position of the material. It should be understood, however, that various other sensors may also be used in the present invention.

The sensors used in the apparatus of the present invention may sense the position of the materials by sensing the position of a single vertical edge of the material. Alternatively, a sensor may be used that can sense both edges of the material. When sensing a single edge, the apparatus assumes that the material has a uniform width for determining the center of the material. When sensing both edges of the material, however, the apparatus can be configured to calculate the center of the material from the information received from the sensor.

One process for initiating a splice sequence using the splicing device 10 as shown in FIGS. 1A, 1B and 2 will now be described in greater detail. As described above, the second material 18 is intended to represent an expiring roll of material that is being fed into a processing line. The first material 16 represents a new material that is to be spliced to the second material 18. The first material 16, in one embodiment, may be threaded into the splicing device 10 adjacent the material joining device 30. In the embodiment shown in FIG. 1A or 1B, the leading edge of the first material 16 may be loaded with an adhesive or with tape for attachment to the second material 18.

When threaded into the splicing device 10, the leading edge of the first material 16 is placed at a known location. For instance, various guides and/or sensors may be present in the splicing device for placing the first material 16 in a particular position. To ensure that the material is placed in the correct position, for instance, the sensor 44 and/or an additional sensor located adjacent the material joining device 30 may be contained in the splicing device. For instance, a further sensor may be positioned on the first contact surface 32 for indicating the position of the leading edge of the first material 16, in both the cross direction and the machine direction. For example, in one embodiment, a D10 photosensor commercially available from the Banner Engineering Corporation of Minneapolis, Minn. may be integrated into the splicing device, such as on the first contact surface 32.

When using sensors to determine the location of the leading edge of the first material 16, in one embodiment, the material is threaded into the splicing device and the sensor indicates when the material is in the correct position. In this embodiment, for instance, an operator adjusts the position of the material until the sensor verifies that the material has been placed at the desired location.

In an alternative embodiment, however, the leading edge of the material is placed in the splicing device. A sensor is then used to indicate the position of the material for aligning the first material with the second material. In this embodiment, the leading edge of the first material need only be placed close to or near a desired center line position.

When the leading edge of the first material 16 is positioned at a known location, a material holding device contained within the splicing device 10 is activated for holding the leading edge of the first material 16 at the known location. The material holding device, for instance, may be a clamp that, for instance, clamps the first material 16 against the anvil 28. For example, in one embodiment, the first guide roll 20 may move against the anvil 28 for holding the web in the proper position. Alternatively, a separate clamping device may be incorporated into the splicing device. In still another alternative embodiment, the material holding device may be a suction device for holding the first material against a surface.

Once the first material 16 is properly threaded into the splicing device 10 and the second material 18 is substantially exhausted, a splicing sequence is initiated. In particular, the position of the second material 18 in the cross machine direction is determined. For instance, sensor 46 may be used to determine the position of the second material 18. The position of the second material 18 is then compared with the position of the first material 16. If it is determined that the two materials are not in alignment, the shifting device 36 is used to move the splicing device 10, and hence the first material 16, in the cross machine direction until it is determined that the materials are aligned.

For instance, in the embodiment illustrated in FIG. 1A, the second material 18 is at a more forward location in the cross machine direction in comparison to the first material 16. Thus, as shown in FIG. 1B, the shifting device 36 is activated causing the splicing device 10 to move in the cross direction as indicated by arrow 48. Since the first material 16 is clamped to the splicing device 10 by the material holding device, movement of the splicing device also causes the first material to move. The second material, on the other hand, is free to glide across the sensor 46 and the guiding roll 22 in the cross machine direction during movement of the splicing device. Consequently, movement of the splicing device 10 does not affect the cross machine position of the second material 18.

In accordance with the present invention, the splicing device 10 is moved by the shifting device 36 until the first material 16 is in alignment with the second material 18 as determined by one or more sensors. When a splice is desired, such as when the second material is substantially exhausted, the material joining device 30 is activated causing the first material to attach to the second material. After the materials are attached, the material holding device releases the first material 16. Further, the knife 26 is activated and is contacted with the anvil 28 for severing the second material 18. Once the two materials are attached together, the second material 18 is severed, the first material 16 is released from the material holding device, and the first material 16 is fed into the processing line for further processing.

Prior to a splicing operation, the apparatus of the present invention may be configured to continuously monitor and make adjustments for maintaining the first material 16 in alignment with the second material 18. Alternatively, the apparatus may be configured such as to only place the materials in alignment when a splice is desired.

After the splicing sequence, the shifting device 36 may once again be activated in order to return the splicing device 10 to a center position. A new roll of material may then be placed at the second unwind station and the remainder of the second material 18 may be removed. The new material may then be threaded into the splicing device for splicing with the first material 16 as the first material is exhausted. In order to provide for two-sided splicing, the second side 14 of the splicing device 10 may also include a sensor located on the second contact surface 34 and/or a material holding device that clamps the new material against, for instance, the anvil 28 or otherwise holds a free edge of the new material at a desired location.

In one embodiment, the splicing operation may all be done automatically. For instance, referring to FIG. 2, the apparatus may further include a controller 50 that is in communication with the sensors 44 and 46 and the shifting device 36. The controller 50 may also be configured to control the knives 24 and 26, the material joining device 30, and the material holding device that holds a free edge of the new material in place. The controller may be, for instance, any suitable microprocessor, such as any suitable programmable logic unit.

In one embodiment, the controller may be configured to receive information from the sensors 44 and 46 and/or from any other sensors contained within the apparatus. The controller, based upon the information received from the sensors, may be configured to compare the position of the first material 16 in relation to the position of the second material 18. If it is determined that the materials are not in alignment, the controller 50 may further be configured to control the shifting device 36 for placing the materials in alignment prior to a splicing sequence.

The sensors 44 and 46 may operate in conjunction with the controller 50 in either an open loop arrangement or a closed loop arrangement. In a closed loop arrangement, continuous feedback is provided to the controller for continuously adjusting the position of the first material in relation to the position of the second material. Whether the system operates in an open loop or a closed loop manner may depend upon the position of the sensors. For instance, if the sensors are attached to a stationary component, the system may operate in an open loop manner. When the sensors are attached to a moving portion of the splicing device, however, the sensors and controller may operate in a closed loop fashion.

In the embodiment illustrated in FIGS. 1A, 1B and 2, the entire splicing device 10 moves in a cross machine direction when the shifting device 36 is activated. In an alternative embodiment, however, the first side 12 and the second side 14 of the splicing device 10 may be separate and movable with respect to each other. In this embodiment, the splicing device 10 may include a first shifting device 36 that is in operative association with the first side 12 and a second shifting device in operative association with the second side 14.

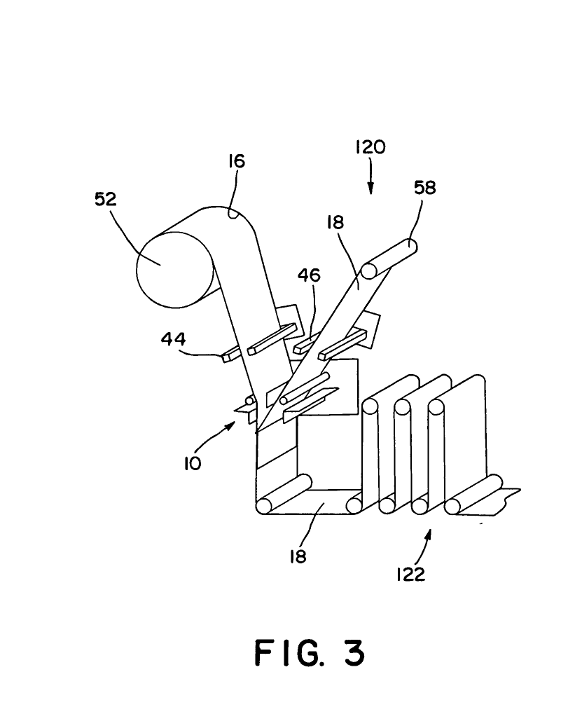

As stated above, the splicing device of the present invention can be used in numerous applications and processes. In one particular embodiment, for instance, the splicing device may be used to feed a material into a processing line that is designed to produce absorbent articles. The absorbent articles may be, for instance, diapers, training pants, swim undergarments, incontinence pads, feminine hygiene products, adult incontinence products, bandages, and the like. The splicing device of the present invention may be used to feed any component of any of the above products into a processing line for forming the products. For exemplary purposes, referring to FIG. 3, one embodiment of an assembly section generally 120 that may be used in making a continuous stream of partially assembled, absorbent articles such as diapers is illustrated. The specific equipment and processes used in assembly section 120 can vary greatly depending upon the specific type of article being manufactured.

The various components of the absorbent articles can be connected together by any means known to those skilled in the art such as, for example, adhesive, thermal and/or ultrasonic bonds. Desirably, most of the components are connected using ultrasonic bonding for improved manufacturing efficiency and reduced raw material costs. For instance, certain garment manufacturing equipment which is readily known and understood in the art, including frames and mounting structures, ultrasonic and adhesive bonding devices, transport conveyors, transfer rolls, guide rolls, tension rolls, and the like which all may be used in constructing the articles.

In general, absorbent articles include a bodyside liner, an outer cover, and an absorbent assembly positioned in between the liner and the outer cover. In addition, the articles can contain various other components for various different purposes. For instance, the articles may include a surge layer positioned adjacent to the liner for assisting in controlling fluid flow. The articles may also include containment flaps, leg elastics, and waist elastics. The articles may also include front side panels and back side panels. The front side panels and the back side panels may be connected or attached to fastening components that allow the articles to be fastened about the waist of a wearer. The fastening components may be, for instance, hook and loop fasteners. For instance, a loop material may be attached to a pair of front side panels while a hook-type material may be attached to the back side panels.

As shown in FIG. 3, a continuous supply of material 18 is fed to the assembly section 120 and used to form a component of the produced articles. As shown, the material 18 is being fed from a depleting roll of material 58. In order to prevent against process downtime and to provide a continuous process, a new roll of material 52 is shown opposite material 18. A material 16 from the roll of material 52 is fed to a splicing device 10 made in accordance with the present invention. Splicing device 10 is for splicing material 16 to material 18 while maintaining the two materials in alignment.

From the splicing device 10, the assembly section 120 includes a festoon 122. The festoon 122 serves as an accumulator that accumulates a determined length of material sufficient to sustain temporary stoppages of the material 18 being unwound, such as during a splice operation. More particularly, the festoon 122 includes a first set of guide rolls spaced from a second set of guide rolls. The first set of guide rolls is in operative association with a carriage. The carriage is movable towards the second set of guide rolls when a desired amount of force is placed on the carriage by the material threaded through the festoon. In this manner, the accumulated material is released downstream when material flow upstream is temporarily halted.

In addition to the festoon 122, the system may further include a dancer roll (not shown) that applies a determined amount of force against the material for feeding the liner material 18 to the process under constant tension. From the dancer roll, the material 18 is then fed into a downstream process and manipulated and used as desired.

In constructing various products, various different types of materials may be fed into a processing line according to the present invention. The material may comprise, for instance, a nonwoven material, an elastic material, and/or a multi-layered laminate.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

1. An apparatus for splicing a first material to a second material comprising:
a first unwind station for unwinding a first roll of material into a processing line in a machine direction;
a second unwind station for unwinding a second roll of material into the processing line in the machine direction;
a splicing device positioned to receive the first material from the first unwind station and the second material from the second unwind station, the splicing device including a material holding device for holding the first material at a determined location, the splicing device further comprising a material joining device that is selectively engageable with the first and second materials, the material joining device being configured to attach the first and second materials together;
a shifting device connected to the splicing device, the shifting device being configured to move the splicing device in a cross machine direction, wherein the lateral position of the first material is changed during movement of the splicing device when the first material is being held by the material holding device;
a sensor for sensing the position of the second material in the cross machine direction; and
a controller in communication with the sensor and the shifting device, the controller being configured to compare the position of the first material at the determined location with the position of the second material based upon information received from the sensor and, based on the comparison, to align the first material with the second material by controlling the shifting device.

2. An apparatus as defined in claim 1, wherein the splicing device further comprises a cutting device for cutting the second material after the second material is spliced to the first material.

3. An apparatus as defined in claim 1, further comprising a material accumulator positioned downstream from the splicing device, the accumulator accumulating a determined length of material sufficient to sustain temporary stoppages by the splicing device during operation of the processing line.

4. An apparatus as defined in claim 3, wherein the accumulator comprises a festoon, the festoon comprising a first set of guide rolls spaced from a second set of guide rolls, the first set of guide rolls being in operative association with a carriage, the carriage being movable towards the second set of guide rolls for releasing material from the festoon during temporary stoppages.

5. An apparatus as defined in claim 1, wherein the controller comprises a microprocessor.

6. An apparatus as defined in claim 1, wherein the splicing device includes a second material holding device for holding the second material at a determined location, the apparatus further comprising a second sensor for sensing the position of the first material in the cross machine direction, the controller being in communication with the second sensor for aligning the first material with the second material when splicing the second material to the first material.

7. An apparatus as defined in claim 1, wherein the sensor comprises an optical sensor.

8. An apparatus as defined in claim 1, wherein the shifting device comprises a fluid cylinder.

9. An apparatus as defined in claim 1, wherein the shifting device comprises a ball screw.

10. An apparatus as defined in claim 1, wherein the sensor senses the position of a vertical edge of the second material.

11. An apparatus as defined in claim 1, wherein the material holding device comprises a suction device.

12. An apparatus as defined in claim 1, wherein the material holding device comprises a clamping device.

13. An apparatus as defined in claim 1, wherein the processing line is configured to produce one of diapers, child's training pants, feminine care articles, and incontinence articles.

14. An apparatus as defined in claim 1, wherein the apparatus comprises a first supply station for unwinding a cover material into the processing line;
a second supply station for unwinding a liner material into the processing line;
an absorbent assembly supply source for supplying absorbent assemblies into the processing line;
the processing line being configured to place the absorbent assemblies in between the cover material and the liner material for forming absorbent articles; and
wherein the first material and the second material that are spliced together by the apparatus comprise a component that is incorporated into the absorbent articles by the processing line.

15. An apparatus as defined in claim 1, wherein the splicing device includes a first side that is movable relative to a second side, the shifting device being configured to move at least one of the sides in relation to the opposite side.

16. An apparatus as defined in claim 1, further comprising a second sensor for sensing the position of the first material, the second sensor being in communication with the controller, the controller receiving information from the first sensor and the second sensor in comparing the position of the first material to the second material.

17. An apparatus for splicing a first material to a second material comprising:
a first unwind station for unwinding a first roll of material into a processing line in a machine direction;
a second unwind station for unwinding a second roll of material into the processing line in the machine direction;
a splicing device positioned to receive the first material from the first unwind station and the second material from the second unwind station, the splicing device comprising a material holding device for holding the first material at a determined location while the second material is being fed into the processing line, the splicing device further comprising a material joining device that is selectively engageable with the first and second materials for attaching the first and second materials together;
a shifting device in operative association with either the first material or the second material, the shifting device being movable in the cross machine direction for changing the position of the first material or the second material respectively in the cross machine direction;
a sensor for sensing the position of the second material in the cross machine direction; and
a controller in communication with the sensor and the shifting device, the controller being configured to compare the position of the first material at the determined location when engaged by the material holding device with the position of the second material based upon information received from the sensor and, based on the comparison, to align the first material with the second material in the cross machine direction prior to splicing the two materials together by controlling the shifting device.

18. An apparatus as defined in claim 17, wherein the splicing device comprises a first side movable relative to a second side, the first side of the splicing device including the material holding device for holding the first material at the determined location, the shifting device being in operative association with the first side of the splicing device for moving the first side in the cross machine direction thereby changing the position of the first material in the cross machine direction.

19. An apparatus as defined in claim 17, wherein the apparatus includes a second sensor for sensing the position of the first material in the cross machine direction, the controller being in communication with the second sensor and being configured to compare the position of the first material with the position of the second material in the cross machine direction based on information received from the sensors for aligning the first material with the second material prior to a splice.

20. An apparatus as defined in claim 17, wherein the splicing device further comprises a cutting device for cutting the second material after the second material is spliced to the first material.

21. An apparatus as defined in claim 17, further comprising a material accumulator positioned downstream from the splicing device, the accumulator accumulating a determined length of material sufficient to sustain temporary stoppages by the splicing device during operation of the processing line.

22. An apparatus as defined in claim 21, wherein the accumulator comprises a festoon, the festoon comprising a first set of guide rolls spaced from a second set of guide rolls, the first set of guide rolls being in operative association with a carriage, the carriage being movable towards the second set of guide rolls for releasing material from the festoon during temporary stoppages.

23. A process for splicing a first material to a second material comprising:
unwinding a first roll of material into a processing line from a first unwind station;
supplying a second material to a splicing device, the splicing device holding the second material at a determined location;
sensing the position of the first material in comparison to the position of the second material in the cross machine direction;
aligning the first material with the second material in the cross machine direction proximate to the splicing device, the first material being aligned with the second material by changing the cross machine position of the first material or the second material; and
splicing the first and second materials together using the splicing device.

24. A process as defined in claim 23, further comprising the step of cutting the first material after the first material is spliced to the second material.

25. A process as defined in claim 23, wherein the first material is aligned with the second material by moving the second material in the cross machine direction, the second material being moved by moving the splicing device in the cross machine direction while the splicing device is holding the second material.

26. A process as defined in claim 23, wherein the position of the first material is determined using an optical sensor.

27. A process as defined in claim 23, wherein an optical sensor is used to determine the position of the first material and determine the position of the second material.

28. A process as defined in claim 26, wherein the optical sensor is in communication with a controller, the controller comparing the position of the first material to the second material and automatically aligning the first material with the second material.
